(19) United States
(12) Patent Application Publication
(10) Pub. No.: US 2008/0294528 A1
(43) Pub. Date: Nov. 27, 2008

(54) Method of providing for rental of clothing

(76) Inventors: William E. Denk, JR., Hanover, PA (US); Ryan E. Hamilton, Bear, DE (US)

Correspondence Address: H. JAY SPIEGEL - H. JAY SPIEGEL & ASSOCIATES, P.O. BOX 11, MOUNT VERNON, VA, 22121, US

(21) Appl. No.: 11/802,431

(22) Filed: May 23, 2007

(51) Int. Cl. G06Q 30/00

(52) U.S. Cl. 705/26

(57) ABSTRACT

In a method for providing for rental of clothing, a client visits a store or other location so that all pertinent measurements can be taken and then stored in a suitable data base. Other data is stored such as preferred style and colors of clothing. Once this has been done, when the client wishes to use the method to obtain clothing while on travel, scheduling of the travel is carried out, and during that scheduling, desired clothing is chosen so that it is ready to be picked up or delivered to the client's living quarters when they arrive at their destination. The operator of the method receives the order and assembles all of the required garments, making sure that they are properly tailored to fit the client. Those garments are then used by the client while they are in that location and when the client is ready to leave the location to travel elsewhere or back to their home, they notify the operator of the method so that the operator can pick up the soiled clothing, dryclean it, and place it back into inventory for the next wearer. Used clothing may be periodically sold.

### BACKGROUND OF THE INVENTION

The present invention comprises a system to eliminate the purchase, distribution and maintenance of suits/garments by the wearer.

As long as man has worn more than a leaf, traveling with extra clothing for a multi-day trip has required some type of container. Suitcases have changed slightly over the past few decades adding wheels for easier movement. But, travelers today are still faced with the same difficulty of having to lug a suitcase or oversized bag with them wherever they go.

This has become increasingly difficult for business travelers as the demands of their positions have required them to work longer hours and travel more, and more often.

With time always being a factor, it is a great inconvenience to stand at a check-in line, especially when those with carry-on baggage only, are able to carry pre-printed tickets straight to security checkpoints. Not to mention the obvious war with cramming as many clothes as possible into a suitcase, trying to make the suitcase fit in the traveler's vehicle (which can be considered an exercise routine in itself), and hoping that it doesn't exceed the weight limit.

In addition, there's the negotiation of the seemingly endless route to baggage claim, only to wait again (and hope that no one else has picked up their baggage accidentally). Or worse yet, to have baggage misplaced, misrouted or lost, especially on multi-destination trips.

All of this has been complicated by recent security procedures which have led to potential delays, inconveniences of having luggage rummaged through by the Transportation Safety Administration (TSA). All of this is for a good purpose but, again, results in an added inconvenience.

Moreover, even the best suitcases inevitably cause wrinkles in clothes upon arrival at the traveler's destination, causing the traveler to either have to send out for drycleaning/pressing, or to grab the hotel's complimentary iron and fix the problem. And best of luck if the iron you're using has had water sitting in it for a while and has rusted. That always looks great on a white shirt. When sending drycleaning out from the hotel, there's always the chance of having pieces missing upon return.

From the perspective of airports and airlines, security has become a great concern since Sep. 11, 2001. Trying to check every possible suspicious bag is a daunting task in itself, coupled with having to ferret out people who might pose a security risk.

Many airlines have had difficulty financially since September, 2001, and with rising fuel costs being an issue, in the end, the costs get passed on to the consumer. If it were possible to set up a business enterprise that would allow business travelers to limit their luggage to “carry on” only, no matter what the length of their travel, or the number of destinations to which they were traveling, it would be advantageous to the travelers, airlines, airports and the security of all. It is with this thought in mind that the present invention was developed.

Reference is made to FIGS. 1, 2 and 3 which consist of flowcharts depicting the typical current manner by which people use articles of clothing. FIG. 1 depicts the process for obtaining a suit or other garment. As is well known, that process starts with a need for the garment, whereupon a person visits a store, purchases the garment, and places the garment into a storage area within their residence.

FIG. 2 shows a flowchart of what occurs after a garment has been acquired. The user removes the garment from storage and wears it. After it is worn, the garment is taken to a cleaning establishment to have it cleaned and pressed. Thereafter, it is restored to the storage area.

FIG. 3 shows a sequence of events that occurs when an owner of a number of garments needs to take garments with them while on a trip.

With reference to FIG. 3, the garment owner removes garments from their closet and packs them in one or more storage devices such as garment bags and suitcases. The bags are placed in a vehicle, either the user's vehicle or perhaps a common carrier such as a taxicab, bus, train or airplane. In the case of an airplane, for example, the owner's vehicle travels to the airport, the bags are transported to check-in when there is check-in baggage or continue to be carried by the user where only “carry on” baggage is employed. Once arriving at the destination, the luggage is transported to the location of the user's accommodations. Clothing is unpacked and used and, if necessary, cleaned and/or pressed prior to use due to the fact that often suits require ironing after having been placed in a suitcase. The clothing is worn and, if desired, stored by the user within a closet of the accommodations. When it is time for the user to return to his or her home or to another destination, all of the articles of clothing are re-packed into the suitcase or suitcases, and are transported to the next destination, whether that be the user's home or another location where the user is traveling. Eventually, in typical fashion, the user returns home, and suitcases are unpacked and garments are cleaned and pressed.

### SUMMARY OF THE INVENTION

The present invention relates to a method of providing for rental of clothing. The present invention includes the following interrelated objects, aspects and features:
1. The traveler begins, for example, by stopping by a retail location of the system or inventive business entity. At this location, the traveler is measured, and he or she is able to try on different styles of clothing/suits as well as shoes, and all information is placed in a database driven site with a special login and password created specifically for the traveler. The system has a central computer connected to the data base and a global computer system such as the Internet. Alternatively, the traveler can provide this information from a remote location by telephone or via the Internet.
2. At that same time, or any time in the future, the traveler may place an order for clothes needed. Typically, orders are placed by customers using their own computers connected to the Internet to communicate with the central computer. Any suitable communication means may be employed.
3. A destination is chosen, for example, San Diego, Calif. (system searches for nearest location).
4. Date of arrival and number of days staying are chosen (system searches for inventory available for that day, based upon traveler's measurements). If the traveler has already specified specific styles, those choices would be presented first. If not, the traveler could choose from a multitude of styles, or items by occasion (business meeting, etc.).
5. Once a choice has been made, the traveler would be presented with accessory choices: shoes, shirt, ties, under garments. The items suggested would be based upon the choices of style or color chosen by the traveler.
6. Preferences would be saved to the database and additional suits could be ordered in the same fashion.
7. The traveler pays via online payment method using any available means such as, for example, a credit card or debit card, and a confirmation is posted on the screen, and sent by e-mail. In addition, the inventory is immediately updated at the location that will be supplying the traveler with their garments.
8. The traveler can make adjustments to their choices at any time, up until a specified period of time prior to delivery (obviously determined by inventory and availability).
9. If the traveler knows the location that they will be staying at the time of the order, they can enter it. Otherwise, they will have a reminder sent to them via e-mail or any other suitable means of communication until they post the location that the order will be delivered.
10. The traveler boards their plane (or other transportation) with carry on luggage, as little as toiletries if getting socks, etc., from the entity.
11. Upon arrival at their destination (check-in) the traveler will sign for the garments that were delivered. This can be done electronically through a device provided by the hotel that reports back to the business entity or through use of any other desired or available means.
12. The items can be placed in the room for the traveler by the hotel. Alternatively, items may be made available at a designated location for pickup. The traveler wears the clothes and upon leaving the hotel, the hotel signs off on the garments as being returned (scan ids in garments or through some other verification means). Receipt of the items by the traveler can be combined with other services such as, for example, pickup of a rental car.
13. The traveler goes to their next destination, or home with just carry on luggage. Other than the benefits of not having to carry and check baggage, some other advantages to the traveler are:

a. No more outdated suits in their closet;

b. No longer having to have items dry-cleaned and pressed;

c. Potential savings, or frequent flyer-type miles from airlines for the space savings provided by the traveler only having carry on luggage;

d. No more lost luggage;

e. Easily adjust sizes in the event the user gains or loses weight. They need just visit any of the business entity's locations to get measured again and have their profile updated;

f. It's all deductible as an ordinary and necessary business expense.
14. The business entity would likely benefit from this system and can also gain drycleaning dollars. From their perspective, the initial visit would likely include:

a. A traveler/customer walks in the door;

b. They get the measurements of the traveler and help find the preferences of the style of clothing, etc., that they prefer;

c. They create a profile in the system for the customer including all measurements, and preferences;

d. They help the customer place their first order if they know when and to where they are traveling.
15. After the first visit, interactions with the customer could include:

a. The destination location receives notification of an order from the system. This order can either speak with the legacy systems of the business, or be its own ordering and fulfillment system;

b. On the night before the order is to be fulfilled, orders are bagged and tagged, ready for delivery. Garments/suits include a scannable identifier;

c. Garments/suits are delivered to the destination locations (hotels), where they are signed as received by the hotel staff;

d. Upon arriving to the hotel or other location where items or garments are to be received, the traveler/customer signs that all items or garments are received in good order. The business entity is notified through a receipt sent through a system like the Internet or other suitable means;

e. Upon check-out, the items are left with the hotel (signed as received) and the business picks them up. This would also be convenient to the business entity because they could be delivering other items to the hotel while they are picking up items that were already worn;

f. Garments are cleaned and returned to inventory.

g. Other advantages to the business entity include:
i. The ability to sell “gently-used” inventory, so that money is made upon the rental or lease uses of the inventory and then again with the sale of the inventory;
ii. Relationships are formed with vendors including but not limited to hotels and online systems such as Travelocity.com and expedia.com to book clothing along with air travel, hotel and vehicles. Systems for booking travel, lodging and transportation may alternatively be incorporated into the system;
iii. Increase web traffic to have users return on a daily basis;
iv. Increase store traffic to users who need to be measured again, want to see gently-used inventory, or try on the latest styles to see how they fit (if the measurements for certain styles need to be adjusted).
16. Airlines will benefit from such a system as follows: Partnering with the business entity to offer an incentive card (or method) to travelers who consistently choose only carry-on by increasing their airline miles for each flight, or offering free upgrades. The reason for this would be that airlines could resell the unused space allotted for the traveler's baggage to UPS, FedEx, USPS or other carriers. If the space is not sold and remains unused, this would save the airline fuel costs (every little bit adds up).

If one considers that a traditional suit off-the-rack sells for between $199 and $300, and one adds to that the cost to dry-clean a suit just once a week ($5 to $7 on average), $6 times 50 weeks a year is $300/year for dry-cleaning one suit only one of 5 business days a year.

Add to that $300, the average cost of a suit at $250, and travelers are already spending approximately $550 per year, per suit. And after a year of use, one suit is about worn out. So, if a convenience fee of $2 were added to the current cost per day to the traveler of $11, the business entity would reap:
1. An additional $100 per suit;
2. Gain additional income on suits that were sold after they were in the inventory;
3. Gain additional income from dry-cleaning the suits. Potentially gain market share in the dry-cleaning market, since the traveler now leaves cleaning entirely up to the business entity. And if they don't currently own a dry-cleaning service, they could either begin one, or get a substantial discount from local cleaners;
4. Gain additional income on accessories for those travelers who want to travel as lightly as possible;
5. Offer a subscription service. For example, if the traveler pays the average $11 per suit, plus the $2 convenience fee for a one-time rental and delivery of a suit: $13, that would represent $65 per week or on a 50 week year $3250 per year or $270 per month. They could receive a discounted rate to $250 per month, which would represent a discount of only $1 per day off of the $2 convenience fee, and at the same time, gain continual business by the traveler. Or, even offer first pick of inventory (one free suit a year) as an incentive;
6. This system even works for local deliveries. One example is in the case where a college student is going on an interview and needs a suit. The business entity gains future executives by being the ones to guide them in looking good for their meeting. Or, even men who rarely wear suits. Those attending a funeral, or special occasion with their family, or the spouse could dress in an outfit that would be in style and fit them well, all for only, say, $20 for a one-time occasion.

In the end, the business entity makes more money by servicing the suit and selling, than just selling the suits alone. The suits through service, will bring a higher price-point than just the sale alone, because it's coupled with other services, like dry-cleaning, and the convenience fees. Overall, the process is a win-win for all involved.

Accordingly, it is a first object of the present invention to provide a method of providing for rental of clothing.

It is a further object of the present invention to provide such a method in which users of the method may order clothing to be delivered at a remote location so that the user does not have to carry clothing in their suitcase on an airplane.

It is a still further object of the present invention to provide such a method in which a user may visit an office to have their physical measurements taken and entered into a data base to facilitate practicing of the method.

It is a yet further object of the present invention to provide such a method in which clothing may be ordered concurrently with reserving travel, lodging and local transportation.

It is a still further object of the present invention to provide such a method which would eliminate the need for checking baggage while on an airplane.

It is a yet further object of the present invention to provide such a method in which the operator of the method would gain business in the drycleaning of soiled garments.

It is a still further object of the present invention to provide such a method in which airlines can provide incentives to use the method such as by offering free miles when the method is used in a manner reducing the amount of baggage below a threshold amount when a user checks-in for a flight.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a flowchart of the typical procedure followed by a consumer to purchase a garment.

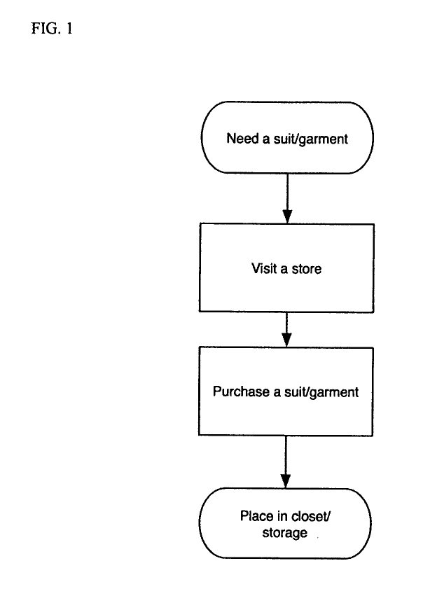

FIG. 2 shows a flowchart of the typical prior art procedure employed by a consumer in using, cleaning and re-storing a garment.

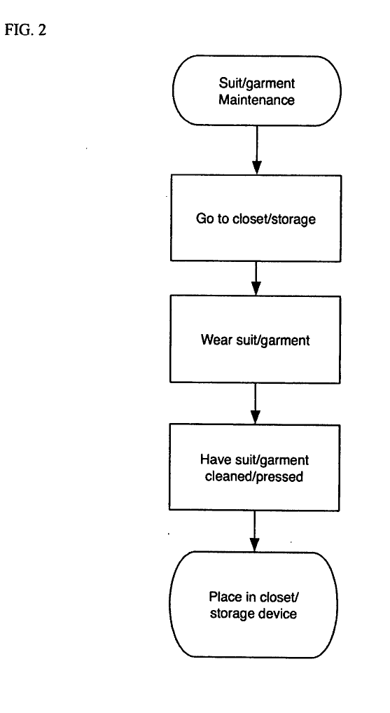

FIG. 3 shows a flowchart of the prior art procedure for traveling with garments owned by the consumer.

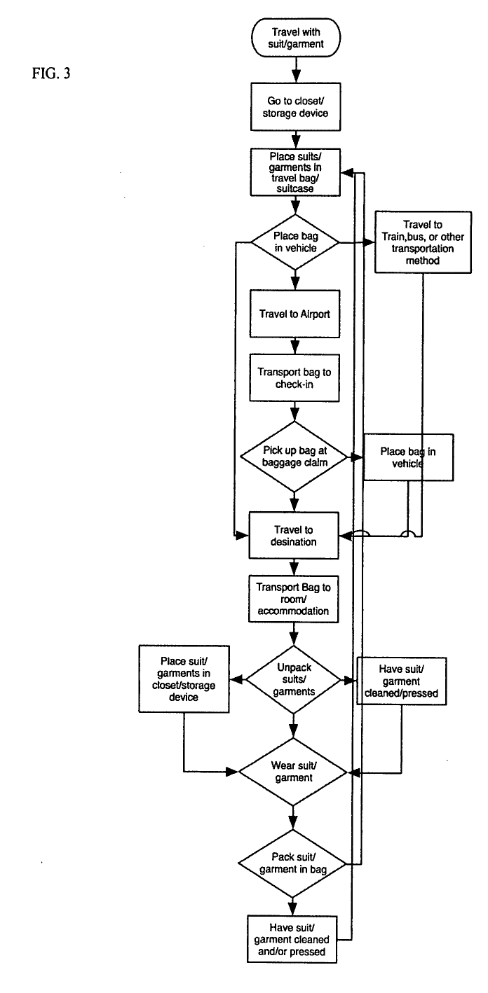

FIG. 4 shows a flowchart of an example of a preferred procedure for practicing the teachings of the present invention.

FIG. 5 shows a flowchart of the inventive procedure in further detail.

### SPECIFIC DESCRIPTION OF THE PREFERRED EMBODIMENT

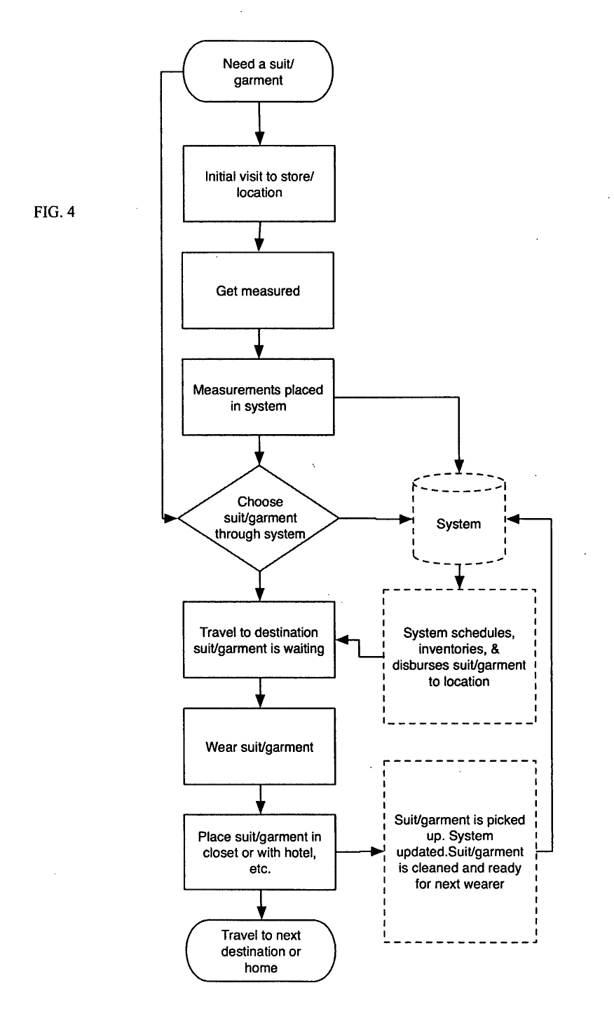

Reference is first made to FIG. 4 which schematically describes a first aspect of the inventive method. As shown, a client of the operator of the method starts out by requiring a garment. Initially, the client visits a store or other location so that all pertinent measurements can be taken and then stored in a suitable data base. Once this has been done, when the client wishes to use the method to obtain clothing while on travel, scheduling of the travel is carried out, and during that scheduling, desired clothing is chosen so that it is ready to be picked up or delivered to the client's living quarters when they arrive at their destination.

The operator of the method receives the order and assembles all of the required garments, making sure that, if necessary, they are properly tailored to fit the client. Those garments are then used by the client while they are in that location and when the client is ready to leave the location to travel elsewhere or back to their home, they notify the operator of the method so that the operator can pick up the soiled clothing, dryclean it, and place it back into inventory for the next wearer.

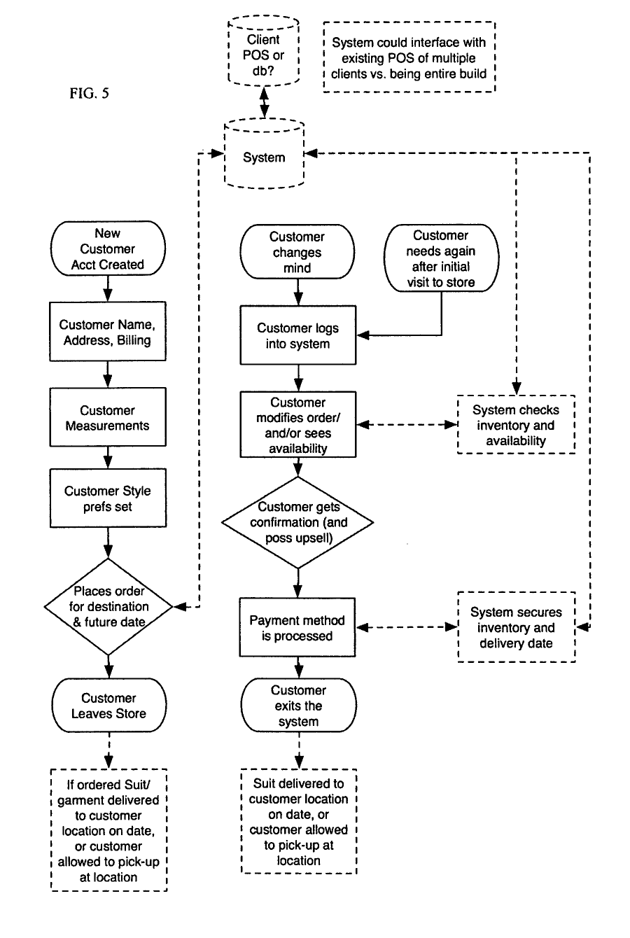

Reference is now made to FIG. 5 which describes other aspects of the method in more detail.

As shown at the top of FIG. 5, the inventive method may be practiced as interfaced with an existing point of sale system having multiple clients as compared to building a client base from scratch. In the left hand column, the manner of creating a customer account is depicted including name, address and billing information for the client, taking and saving of customer measurements, and stating in the data base the style preferences of the customer. Once this information has been stored, the customer may place an order including stating a destination where the clothing will be picked up or received and the dates when the customer will arrive and depart.

As depicted in the flowchart, the customer may change their mind and modify the order in any respect such as, for example, as to style, color, and other clothing criteria as well as concerning criteria regarding the travel plans of the customer.

The system may be computerized so that it is easy to receive and process customer orders as well as to check availability of ordered clothing and availability of ordered clothing by date and location. As described with reference to FIG. 4, a customer can arrange so that when they arrive at a distant location from their home, the clothing they have ordered is either ready to be picked up at a local store location or delivered to the location of lodging of the customer.

Any desired means of payment may be utilized in accordance with the teachings of the present invention including credit and debit cards as well as checks, cash or gift cards for that matter.

The operator of the system may, if desired, periodically put up for sale clothing that has been slightly used and slightly worn so as to recoup some of the expense of acquiring the clothing inventory.

Through use of the present invention, travel by consumers is made easier since they don't have to worry about checking baggage in an airplane or train, extending the length of time during which they must undergo a security check, risking lost baggage, and straining their bodies carrying heavy suitcases from place to place.

As explained above, through use of the present invention, if the average airline passenger brings less baggage to the airplane, the now available storage space can be more efficiently utilized, for example, by overnight courier services. In this way, over the long run, fewer airplanes will be necessary to fly passengers as well as freight. This will not only reduce dependence on fossil fuels, it will reduce air pollution as well as global warming.

Accordingly, an invention has been disclosed in terms of a preferred embodiment thereof which fulfills each and every one of the objects of the invention as set forth hereinabove, and provides a new and useful method of providing for rental of clothing of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. A method of providing for rental of clothing, including the steps of:
a. Providing a system including at least two offices located at spaced geographical locations;
b. Said system including a data storage facility to facilitate storing data related to customer clothing specifications;
c. Providing equipment at each office (i) to facilitate taking data consisting of (1) measurements of customers as well as (2) information concerning types, styles and colors of clothing preferred, and (ii) to enter said data into said data storage facility;
d. Storing said data in said data storage facility;
e. Providing a communication system to facilitate customers ordering clothing from remote locations to be provided pursuant to a requested schedule;
f. Customers ordering clothing using said communication system with data being retrieved from said data storage facility to facilitate completion of an order; and
g. Providing said clothing.

2. The method of claim 1, wherein said communication system includes a telephone.

3. The method of claim 1, wherein said communication system includes each customer employing a computer connected to a global computer system.

4. The method of claim 3, wherein said system includes a central computer connected to said global computer system to facilitate communication with customer computers.

5. The method of claim 4, wherein said data storage facility is associated with said central computer.

6. The method of claim 1, wherein said step of providing said clothing includes the step of making said clothing available for pickup at a designated location.

7. The method of claim 6, wherein said designated location comprises one of said offices.

8. The method of claim 6, wherein said designated location comprises a location chosen by a customer.

9. The method of claim 1, wherein said step of providing said clothing includes the step of delivering said clothing to a requested location.

10. The method of claim 9, wherein said requested location is a hotel.

11. The method of claim 1, further including the step of associating said system with a reservation system used by customers to facilitate booking of travel transportation, lodging and rental vehicles.

12. The method of claim 11, wherein said travel transportation comprises airplane travel.

13. The method of claim 1, further including the step of associating said system with a cleaning facility to facilitate cleaning soiled clothing for re-use by customers.

14. The method of claim 1, further including the step of associating said system with a payment operation permitting payment for services by credit card or debit card.

15. The method of claim 1, further including the step of selling used clothing.

16. A method of providing for rental of clothing, including the steps of:
a. Providing a system including at least two offices located at spaced geographical locations;
b. Said system including a data storage facility to facilitate storing data related to customer clothing specifications;
c. Providing equipment at each office (i) to facilitate taking data consisting of (1) measurements of customers as well as (2) information concerning types, styles and colors of clothing preferred, and (ii) to enter said data into said data storage facility;
d. Storing said data in said data storage facility;
e. Providing a communication system to facilitate customers ordering clothing from remote locations to be provided pursuant to a requested schedule including a central computer associated with said data storage facility and connected to a global computer system, and each customer employing a computer connected to a global computer system to communicate with said central computer;
f. Customers ordering clothing using said communication system with data being retrieved from said data storage facility to facilitate completion of an order;
g. Providing said clothing, and
h. Associating said system with a reservation system used by customers to facilitate booking of travel transportation, lodging and rental vehicles.

17. The method of claim 16, wherein said designated location comprises one of said offices.

18. The method of claim 16, wherein said step of providing said clothing includes the step of delivering said clothing to a requested location.

19. The method of claim 18, wherein said requested location is a hotel.

20. The method of claim 16, further including the step of associating said system with a cleaning facility to facilitate cleaning soiled clothing for re-use by customers.

21. The method of claim 16, further including the step of associating said system with a payment operation permitting payment for services by credit card or debit card.

22. The method of claim 16, further including the step of selling used clothing.
